(19) United States
(12) Patent Application Publication
(10) Pub. No.: US 2004/0197179 A1
(43) Pub. Date: Oct. 7, 2004

(54) Method and apparatus for vertical transfer of semiconductor substrates between cleaning modules

(75) Inventors: Younes Achkire, Los Gatos, CA (US); Dan Marohl, San Jose, CA (US); Lakshmanan Karuppiah, San Jose, CA (US)

Correspondence Address: Patent Counsel, Applied Materials, Inc., P.O. Box 450A, Santa Clara, CA, 95052, US

(73) Assignee: Applied Materials, Inc.

(21) Appl. No.: 10/408,036

(22) Filed: Apr. 3, 2003

(51) Int. Cl. B66F 1/00

(52) U.S. Cl. 414/618

(57) ABSTRACT

A substrate handler is provided comprising a carriage positionable along a first axis of motion, a first substrate gripper coupled to the carriage and positionable relative to the carriage along a second axis of motion oriented substantially perpendicular to the first axis of motion, and a second substrate gripper coupled to the carriage and positionable relative to the carriage along a third axis of motion oriented substantially parallel to the second axis of motion, wherein the second gripper is independently movable relative to the first gripper.

### FIELD OF THE INVENTION

Embodiments of the invention generally relate to a method and apparatus for handling semiconductor substrates.

### BACKGROUND OF THE INVENTION

In the process of fabricating modern semiconductor integrated circuits (ICs), it is necessary to deposit various material layers over previously formed layers and structures. However, the prior formations often leave the top surface topography unsuitable for deposition of subsequent layers of material. For example, when printing a photolithographic pattern having small geometries over previously formed layers, a very shallow depth of focus is required. Accordingly, it becomes essential to have a flat and planar surface, otherwise, some parts of the pattern will be in focus and other parts will not. In addition, if the irregularities are not leveled prior to certain processing steps, the surface topography of the substrate can become even more irregular, causing further problems as the layers stack up during further processing. Depending on the die type and the size of the geometries involved, the surface irregularities can lead to poor yield and device performance. Consequently, it is desirable to achieve some type of planarization, or polishing, of films during IC fabrication.

One method for achieving semiconductor substrate planarization is chemical mechanical polishing (CMP). In general, CMP involves the relative movement of a semiconductor substrate against a polishing material to remove surface irregularities from the substrate. The polishing material is wetted with a polishing fluid typically containing at least one of an abrasive or chemicals.

Once polished, the semiconductor substrate is transferred to a series of cleaning modules that remove the abrasive particles and/or other contaminants that cling to the substrate after polishing. The cleaning modules must remove any remaining polishing material before it can harden on the substrate and create defects. These cleaning modules may include, for example, a megasonic cleaner, a scrubber or scrubbers, and a dryer. Cleaning modules that support the substrates in a vertical orientation are especially advantageous, as they also utilize gravity to enhance the removal of particles during the cleaning process and are also typically more compact.

Although present CMP systems have been shown to be robust and reliable systems, the configuration of the system equipment requires the substrates to be cleaned in a rigid, inflexible process sequence. Specifically, the design of some substrate handlers that transfer semiconductor substrates between various cleaning modules prevents a cleaning system from deviating from a single process sequence, as some handlers feature multiple transfer devices that are rigidly spaced and controlled in unison.

The operation of such substrate handlers can best be understood with reference to FIG. 1, which illustrates a prior art substrate handler 3 in a cleaning system 1. The handler 3 is positioned above a series of cleaning modules n₀ to nᵢ₊₁, where n is a positive integer. A handler 3 typically includes a horizontal track 4, a sliding carriage 2 mounted on the track 4 and a plurality of gripping devices 6A-C (hereinafter collectively referred to as “6”) for gripping substrates. A plurality of vertical tracks 10A-10C (hereinafter collectively referred to as “10”) on the carriage 2 supports a horizontal rail 8 that is coupled to the plurality of gripping devices 6 and movable vertically with respect to the carriage 2. As the rail 8 drops vertically toward the cleaning modules, each of the plurality of gripping devices 6 drops with it and into a respective cleaning module, where the gripping device 6 removes a substrate from the module. The rail 8 is then raised vertically, raising the gripping devices 6, and the carriage 2 moves horizontally so that each gripping device 6 is positioned above the next adjacent cleaning module. Each gripping device 6 then places its substrate within that next adjacent cleaning module. This sequence is repeated several times so that each substrate is processed sequentially within each module in the cleaning sequence.

As illustrated, this sequence requires precise calibration of the relative position of each component to ensure that the substrate handlers and the substrate supports within each of the cleaning modules are configured to smoothly transfer the substrates without damage. For example, the gripping devices 6 must be located equal distances d₁ apart along the length of the rail 8. The distance d₁ furthermore must be equal to the distance d₂ between each set of substrate supports 12A-C (hereinafter collectively referred to as “12”) within the cleaning modules. All sets of substrate supports 12 must also be located, at all times, at equal vertical distances d₃ from the rail 8. Therefore, the gripping devices 6 are generally calibrated to simultaneously travel equal vertical distances d₃ to extract or deposit a substrate in a cleaning module, and then travel equal horizontal distances d₂ to the next cleaning module. Consequently, altering the cleaning process sequence from one batch of substrates to the next, even if the change only affects one cleaning module, can require reconfiguration of a significant part of the system. It is difficult, for example, to skip a cleaning module if desired, because all substrates must be sequentially transferred to the next adjacent module. Furthermore, since each of the plurality of gripping devices 6 is a fixed distance d₃ from each of the substrate supports 12, the calibration from module to module must be very tight in order to correctly transfer the substrates throughout the cleaning sequence. This requires precise and time-consuming adjustment on each machine, and this adjustment must be repeated every time a gripping device or cleaning module is replaced.

Thus, there is a need in the art for a versatile substrate handler for use in an automated cleaning system that is easily configurable for various process sequences.

### SUMMARY OF THE INVENTION

In one embodiment, the invention provides a substrate handler comprising a carriage positionable along a first axis of motion, a first substrate gripper coupled to the carriage and positionable relative to the carriage along a second axis of motion oriented substantially perpendicular to the first axis of motion, and a second substrate gripper coupled to the carriage and positionable relative to the carriage along a third axis of motion oriented substantially parallel to the second axis of motion, wherein the second gripper is independently movable relative to the first gripper.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a prior art substrate handler;

FIG. 2 depicts a top view of a semiconductor substrate polishing and cleaning system for use with embodiments of the invention;

FIG. 3 illustrates a perspective view of a semiconductor substrate handler according to one embodiment of the invention;

FIG. 4 illustrates a perspective view of the back of a substrate handler according to the embodiment described in FIG. 3;

FIG. 5 illustrates a perspective view of a substrate gripping assembly for use with embodiments of the invention;

FIGS. 6A-F depict a simplified diagrammatic representation of the operation of a semiconductor substrate handler according to one embodiment of the present invention;

FIG. 7 is a perspective view of an alternate substrate gripping assembly;

FIG. 8 is a perspective view of one embodiment of an end effector of the alternate substrate gripping assembly of FIG. 7;

FIG. 9 is a perspective view of a second embodiment of an end effector of the alternate substrate gripping assembly of FIG. 7; and

FIG. 10 is a perspective view of a third embodiment of an end effector of the alternate substrate gripping assembly of FIG. 7.

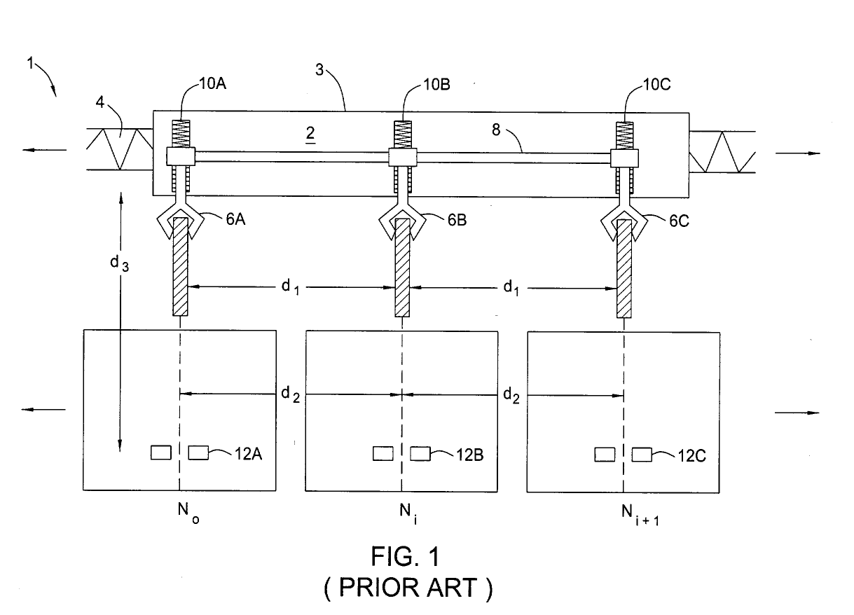

To facilitate understanding, identical reference numerals have been used, where possible, to designate identical elements that are common to the figures.

### DETAILED DESCRIPTION

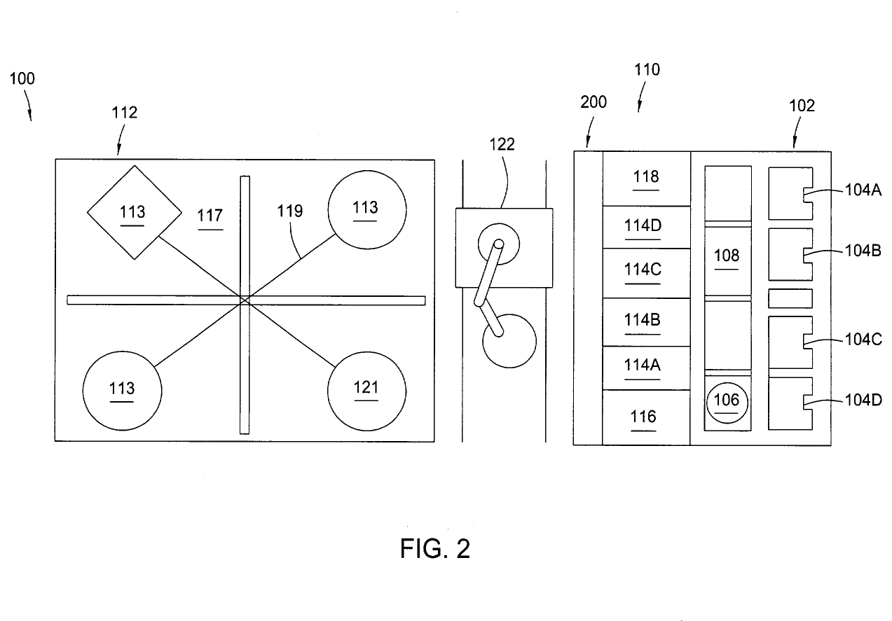

FIG. 2 depicts a top view of a chemical mechanical polishing (CMP) system 100. The system 100 includes a factory interface 102, a polisher 112, and a cleaner 110 having a substrate handler 200 of the present invention.

The factory interface 102 stores polished substrates as well as substrates waiting to be polished. The factory interface 102 includes a plurality of bays, each accepting a substrate storage cassette 104A-D (hereinafter collectively referred to as “104”), and at least one robot 106 positionable along a track 108 that is parallel to the row of cassettes 104 and to the cleaner 110 and the polisher 112. The robot 106 is configured to transfer substrates to be polished from the cassettes 104 to an input module 116 disposed in the cleaner 110, and to return cleaned substrates from the cleaner 110 back to the cassettes 104. One example of a factory interface that may be adapted to benefit from the invention is described in U.S. Pat. No. 6,413,356, issued Jul. 2, 2002, which is hereby incorporated by reference in its entirety. Suitable factory interfaces are also commercially available from Applied Materials, Inc., located in Santa Clara, Calif.

The polisher 112 planarizes substrates transferred from the input module 116 to the polisher 112 by a substrate carrier 122. One polisher that may benefit from incorporation of the present invention is the REFLEXION® chemical mechanical polishing system commercially available from Applied Materials, Inc. Another such polisher is described in U.S. Pat. No. 6,244,935, issued Jun. 12, 2001, which is herein incorporated by reference in its entirety. In one embodiment, the polisher 112 includes a plurality of polishing stations 117, a transfer station 121, and a rotatable carousel 119. The transfer station 121 accepts substrates from the substrate carrier 122 and transfers the substrates to one of a plurality of polishing heads (not shown) coupled to the arms of the carousel 119. The carousel 119 is supported above the polishing stations 117 and indexes the substrates between the polishing stations 117 for processing. Typically, each polishing station 117 includes a rotatable platen 113 that supports polishing material on which the substrate is processed. The polishing material may be a conventional foam pad or a web of fixed-abrasive polishing pad. In one embodiment, at least one of the rotatable platens 113 is rectangular in shape and supports a web of fixed abrasive polishing material. Substrates are held against the polishing pads on the platens 113, and relative movement between the substrates and the platens 113 removes surface irregularities from the substrates, thus planarizing them for further processing. After polishing, the substrates are returned from the carousel 119 to the transfer station 121, where the substrates are then moved to the cleaner 110 by the substrate carrier 122.

The cleaner 110 removes polishing debris and/or polishing fluid from the polished substrates that remains after polishing. One cleaner that may be adapted to benefit from the present invention is described in U.S. patent application Ser. No. 10/286,404, filed Nov. 1, 2002, which is herein incorporated by reference in its entirety. In one embodiment, the cleaner 100 includes a plurality of single substrate cleaning modules 114A-D (hereinafter collectively referred to as “114”), as well as the input module 116, an output module 118 and a substrate handler 200 disposed above the plurality of modules 114, 116, 118. The input module 116 serves as a transfer station between the factory interface 102, the cleaner 110, and the polisher 112. The output module 118 facilitates substrate transfer between the cleaner 110 and the factory interface 102. Substrates are indexed through the plurality of modules 114, 116, 118 by the substrate handler 200 during cleaning.

In the embodiment depicted in FIG. 2, the cleaner 110 includes four cleaning modules 114; however, it is to be appreciated that the invention may be used with cleaning systems incorporating any number of modules. Each of the modules 114, 116,118 is adapted to support a vertically oriented substrate. The cleaning modules 114 may comprise, for example, a megasonic cleaner 114A, a first scrubber 114B, a second scrubber 114C, and a spin-rinse-dryer 114D, although other configurations are contemplated.

In operation, the system 100 is initiated with a substrate being transferred from one of the cassettes 104 to the input module 116 by the robot 106. The substrate carrier 122 then removes the substrate from the input module 116 and transfers it to the polisher 112, where the substrate is polished while in a horizontal orientation. Once the substrate is polished, the substrate carrier 122 extracts the substrate from the polisher 112 and places it in the input module 116 in a vertical orientation. The substrate handler 200 grabs the substrate from the input module 116 and indexes the substrate through at least one of the modules 114 of the cleaner 110. Each of the modules 114 is adapted to support a substrate in a vertical orientation throughout processing. Once cleaned, the handler 200 transfers the substrate to the output module 118, where it is flipped to a horizontal orientation and returned by the robot 106 to one of the cassettes 104.

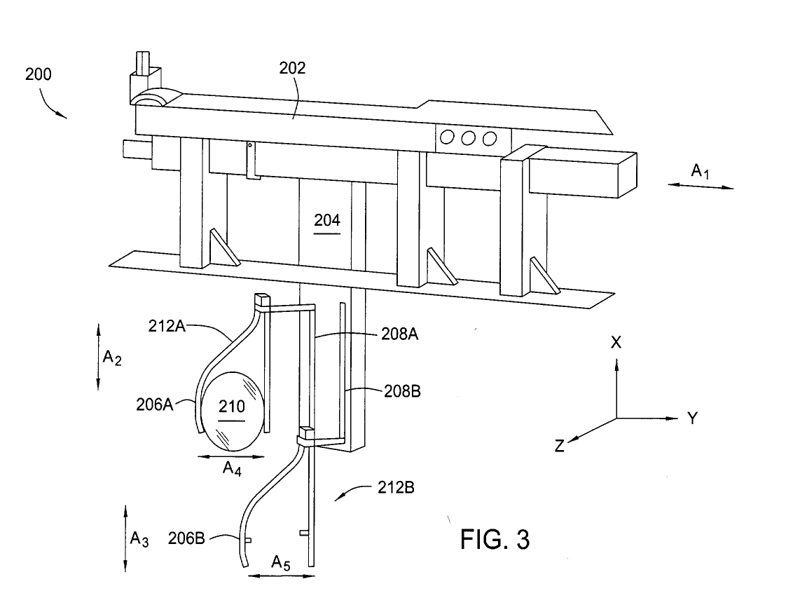

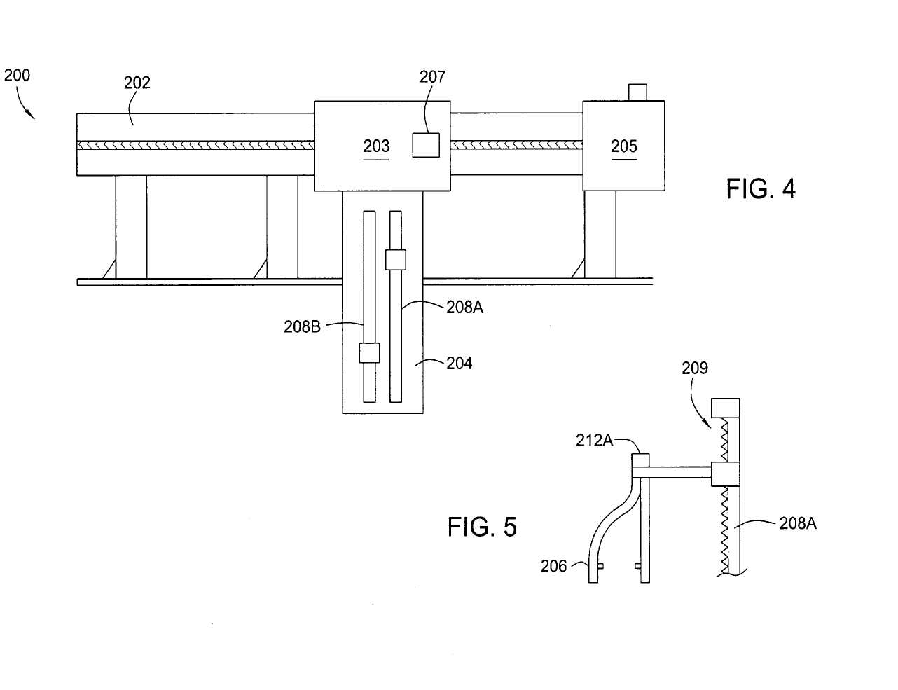

The semiconductor substrate handler 200 is illustrated in FIGS. 3-5. FIG. 3 illustrates a perspective view of a semiconductor substrate handler 200 according to one embodiment of the invention. The substrate handler 200 includes a horizontal beam or track 202, a carriage 203 (shown in FIG. 4), a mounting plate 204, and at least two substrate gripping assemblies 212A-B (hereinafter collectively referred to as “212”). The carriage 203 (shown in FIG. 4, which depicts a perspective view of the back of a substrate handler 200) is mounted on the track 202 and is driven horizontally along a first axis of motion A₁ (shown in FIG. 3), defined by the track 202, by an actuator 207 (depicted in FIG. 4). The actuator 207 includes a motor 205 coupled to a lead screw that moves a drive nut (not shown) attached to the carriage 203. As the drive nut is urged laterally by the rotating lead screw, the carriage 203 is moved along the track 202. Alternatively, the actuator 207 may be any form of a linear actuator for controlling the position of the carriage 203 along the track 202. In one embodiment, the carriage 203 is driven by a linear actuator having a belt drive, such as the GL15B linear actuator commercially available from THK Co., Ltd. located in Tokyo, Japan.

The carriage 203 is coupled to a mounting plate 204. The mounting plate 204 includes at least two parallel tracks 208A-B along which two independently controlled substrate gripping assemblies 212A-B are driven, respectively, along second and third axes of motion A₂ and A₃, oriented perpendicular to the first axis A₁.

One embodiment of the substrate gripping assembly 212A is illustrated further in FIG. 5. The substrate gripping assembly 212B is similarly configured. The gripping assembly 212A comprises a substrate gripping device 206 and an actuator 209. The actuator 209 may be a lead screw or solenoid (although other forms of actuators may be used, for example, a rack and pinion), and it drives the gripping device 206 vertically along the track 208A in the direction defined by the second axis of motion A₂. In one embodiment, the actuator 209 is a lead screw slide assembly commercially available from THK Co., Ltd. The gripping device 206 is configured to grip the outer edges of a substrate that is oriented in a vertical position (as shown in FIG. 3). Alternatively, the gripping device 206 may be a robotic end effector having an electrostatic chuck, vacuum chuck, edge clamp or other substrate gripping device.

Referring back to FIG. 3, the handler 200 is capable of at least three axes of motion with respect to the cleaner 110: one horizontal (x axis—along the track 202, see first axis A₁) and at least two vertical (y axis—one each for the at least two independently controllable gripping devices 206, see second and third axes A₂ and A₃). In addition, each gripping device 206 has an additional axis A₄, A₅ of motion along the plane in which it grips the substrate (z axis—i.e. coplanar with the substrate's circumference), which is perpendicular to the axes A₁-A₃.

It is a benefit of the substrate handler 200 of the present invention that the gripping devices 206 are capable of moving independently of one another, thus allowing process sequences within the cleaner to be varied. Furthermore, two gripping devices 206 on one arm 204 may effectuate a substrate swap in one cleaning module, without affecting the processes or operation in other modules.

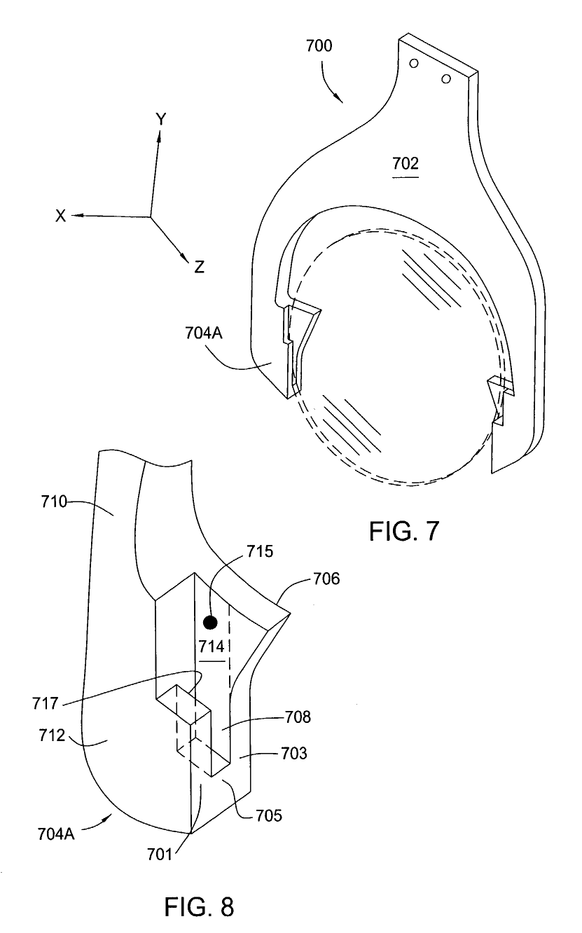

One embodiment of an alternate substrate gripping assembly 700 that may be advantageously adapted for use with the present invention is illustrated in FIG. 7. The substrate gripping assembly 700 is designed to retain a vertically oriented substrate (shown in phantom) without the use of clamps or other chucking devices (such as vacuum or electrostatic chucks and the like). The gripping assembly 700 features a generally U-shaped blade 702 having two end effectors 704A and 704B (hereinafter collectively referred to as “704”).

One embodiment of the end effector 704A is shown in greater detail in FIG. 8, while the end effector 704B is configured in the mirror image thereof. The end effector 704A comprises an arm 710 that converges with the “U” of the blade 702 and a lower end 712. The lower end 712 features a first flange 701 that extends inward toward the middle of the “U” of the blade 702 and a second flange 703 that is substantially parallel to and spaced apart from the first flange 701. The second flange 703 further comprises a substantially flat shoulder 706 proximate the arm 710 that extends inward (i.e., toward the middle of the “U” of the blade 702) from the second flange 703. The first and second flanges 701, 703 are connected by a substrate support 705 that is substantially perpendicular to the flanges 701, 703. The flanges 701, 703, in combination with the substrate support 705, define a shallow U-shaped groove, or substrate receiving pocket 708 in the lower end 712 of the end effector 704A.

In operation, the blade 702 is moved along two axes to capture the substrate: one perpendicular to the substrate plane (i.e., the x axis), and one parallel vertically to the substrate plane (i.e., the y axis) to capture the substrate from the bottom and lift it up. That is, the blade 702 moves vertically, downward toward the substrate, keeping behind the substrate and stopping slightly below it. The blade 702 then moves horizontally, forward toward the substrate in front of it until the back of the substrate is contacted by the blade 702. Finally, the blade 702 moves vertically, upward to capture the substrate in the substrate receiving pockets 708 of the end effectors 704. The substrate is supported on each side by the flanges 701, 703, while supported from below by the substrate support 705. The shoulders 706 extending from the second flanges 703 provide an extra measure of support when the captured substrate is moved in the x direction on the blade 702 (e.g., from one cleaning module to the next). This is also facilitated by the longer length of the second flange 703 relative to the first flange 701, as measured from the substrate support 705. The flanges 701, 703 help to keep the substrate held within the pockets 708 by ensuring that the substrate does not tilt forward or backward. In this manner, gravity will enable the pockets 708 on the end effectors 704 to capture the substrate securely. Thus, the substrate is gripped using gravity, rather than a mechanical actuator or chucking device, to secure its position. Alternatively, motion of the substrate gripping assembly 700 may be optimized so that the blade 702 moves simultaneously in 2 axes, rather than confine the movement to individual steps.

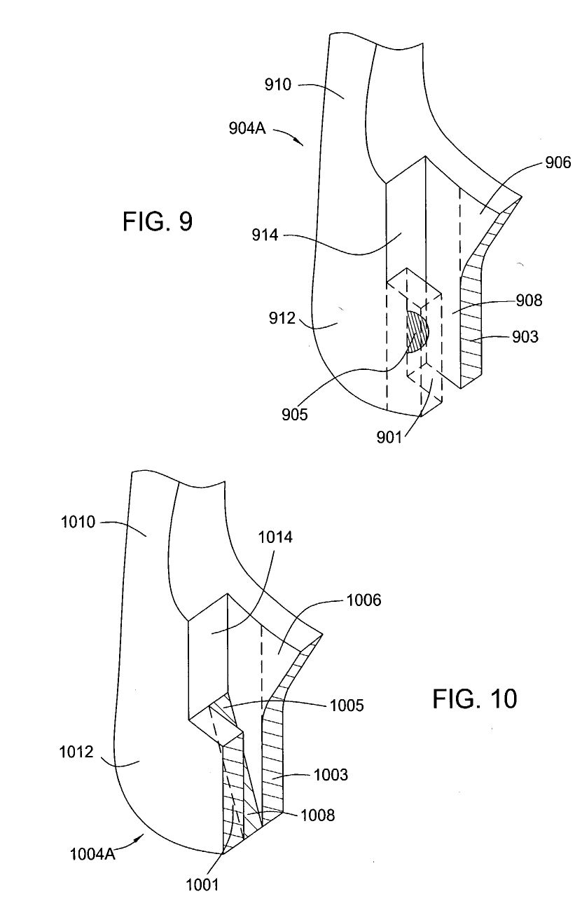

FIG. 9 illustrates a second embodiment of an end effector 904A. The end effector 904A comprises an arm 910 that converges with the “U” of the blade 702 and a lower end 912. The lower end 912 features a first flange 901 that extends inward toward the middle of the “U” of the blade 702 and a second flange 903 that is substantially parallel to and spaced apart from the first flange 901. The second flange 903 further comprises a substantially flat shoulder 906 proximate the arm 910 that extends inward (i.e., toward the middle of the “U” of the blade 702) from the second flange 903. The first and second flanges 901, 903 are connected by a substrate support 905 that comprises a bump or protrusion extending inwardly from an inner wall 914 of the end effector 904A to a distance that prevents the substrate from passing vertically through between the flanges 901, 903. The flanges 901, 903, in combination with the substrate support 905, define a shallow U-shaped groove, or substrate receiving pocket 908 in the lower end 912 of the end effector 904A.

A third embodiment of an end effector 1004A is illustrated in FIG. 10. The end effector 1004A comprises an arm 1010 that converges with the “U” of the blade 702 and a lower end 1012. The lower end 1012 features a first flange 1001 that extends inward toward the middle of the “U” of the blade 702 and a second flange 1003 that is substantially parallel to and spaced apart from the first flange 1001. The second flange 1003 further comprises a substantially flat shoulder 1006 proximate the arm 1010 that extends inward (i.e., toward the middle of the “U” of the blade 702) from the second flange 1003. The first and second flanges 1001, 1003 are connected by a substrate support 1005 that comprises a substantially flat surface angled with respect to an inner wall 1014 of the end effector 1004A. The flanges 1001, 1003, in combination with the substrate support 1005, define a shallow U-shaped groove, or substrate receiving pocket 1008 in the lower end 1012 of the end effector 1004A. The pocket 1008 gradually tapers in depth, so that the distance from the substrate support 1005 on end effector 1004A across to an identical substrate support on a mirror image end effector (i.e., the distance across the blade 702 from substrate support to substrate support) is smaller than the diameter of the substrate to be supported by the end effectors 1004. Therefore, the shorter distance between the angled substrate supports 1005 prevents the substrate from passing vertically through the flanges 1001,1003.

Referring back to FIG. 8, a sensor 715 may be optionally included to detect the presence of a substrate on the end effectors 704. In one embodiment, the sensor is a fiber optic sensor in which a sensor 715 and receiver are positioned, offset from each other, on opposite faces of an end effector 704. The sensor 715 is positioned, for example, on a first face 714 (i.e., facing toward the pocket 708) of the second flange 703. The receiver (not shown) is positioned, for example, across the pocket 708 on the facing surface 717 of the first flange 701. A beam of light passes across the pocket 708 from the sensor 715 to the receiver. Thus if light is transmitted to the receiver, this implies that there is no substrate upon the end effectors 704 to block the sensor 715. In the alternative, if a substrate is present upon the end effectors 704, it will block light from the sensor 715 to the receiver, thus verifying the presence of the substrate. It will be appreciated that other forms of sensors may be used with embodiments of the invention, such as proximity or limit switches. However, cost and complexity of integration into the equipment will be a factor in determining which sort of sensor is most advantageously used.

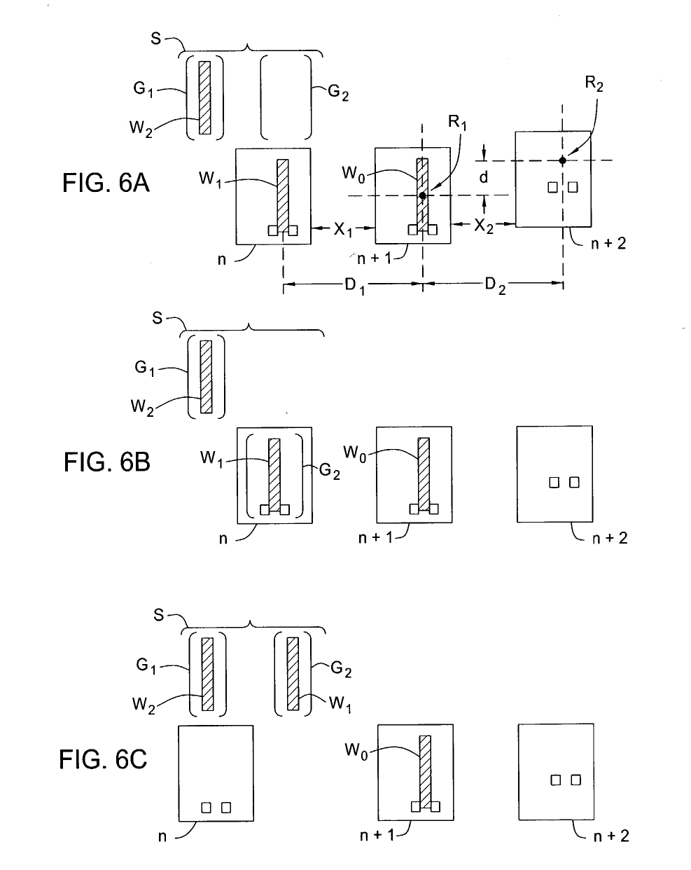

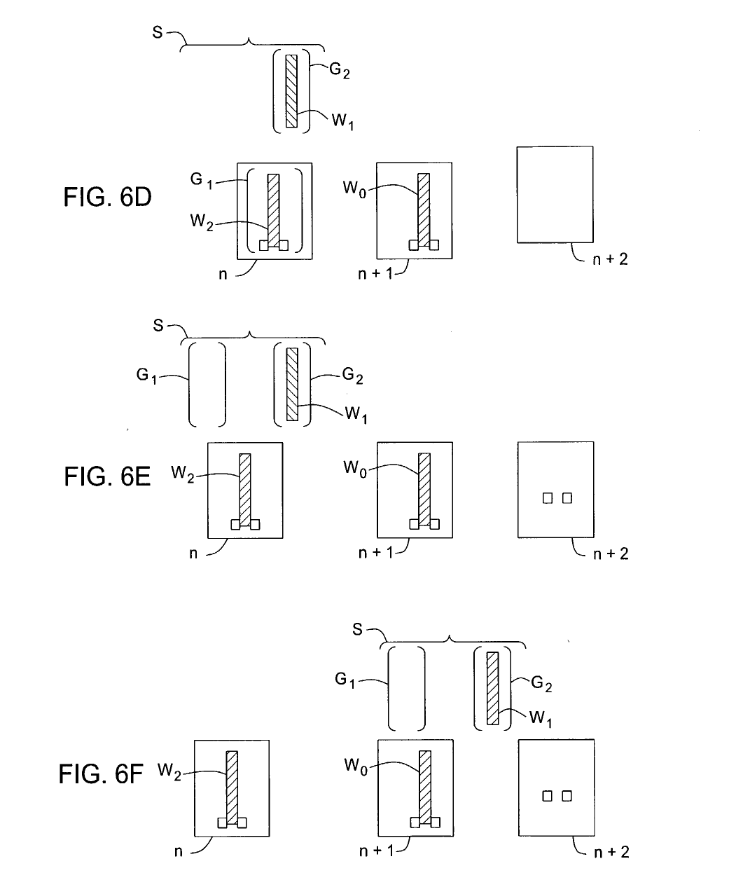

The operation of the substrate handler according to the present invention with respect to the cleaner is best understood with reference to FIGS. 6A-F, which depict simplified diagrammatic representations of various stages in the substrate transfer process through the cleaner 110. The cleaner 110 may be configured with any number of single substrate cleaning modules, and is shown with three adjoining modules in FIGS. 6A-F for simplicity. FIG. 6A depicts three single substrate cleaning modules: n, and the adjacent modules n+1 and n+2. At the first stage in a cleaning sequence, module n contains a substrate w₁ and module n+1 contains a substrate w₀. A substrate handler S, positioned above the module n, features two independently movable gripping devices G. and G₂. The gripping device G₁ holds a substrate w₂. The goal of one exemplary mode of operation is to swap the substrate w₂, held by the gripping device G₁ of the substrate handler S, with the substrate w₁ in the module n.

Continuing to FIG. 6B, the substrate handler S moves horizontally along a first axis of motion and positions itself over the module n so that the gripping device G₂ can move vertically, along a second axis of motion, into the module n and grip the substrate w₁ for removal. The substrate w₁ is then removed from the module n, as illustrated by FIG. 6C. The substrate handler S then moves over horizontally, again along the first axis of motion, so that the gripping device G₁ may move vertically, along a third axis of motion, into the module n (FIG. 6D) and place within the unprocessed substrate w₂ (FIG. 6E). Thus, the substrate handler S has effectuated a swap of substrates w₁ and w₂ in module n, without affecting processes in any other modules of the cleaner. The substrate handler S then moves over to the next module, n+1 (FIG. 6F), and repeats the process, swapping substrate w₁ from the previous module, n, with substrate w₀, and so on. Alternatively, the substrate handler S may swap the substrates w₁ and w₂ within module n, and skip over the module n+1 to the module n+2, depositing the substrate w₁ in module n+2 and leaving the substrate w₀ in module n+1.

Referring back to FIG. 6A, it is to be appreciated that a further benefit of the present invention is its adaptability to individually configured cleaning modules; that is, the various cleaning modules in the cleaner do not necessarily need to be configured to support substrates in identical orientations or positions. For example, in FIG. 6A, cleaning modules n+1 and n+2 feature substrate supports that are located at different elevations, separated by a deviation d, within the respective cleaning modules n+1 and n+2. Thus substrate reference points R₁ and R₂ (defined by where the intersection of the midpoints of a substrate's thickness and width/diameter would sit in a module) are at different locations within their respective cleaning modules n+1 and n+2. Prior art substrate handlers such as those described herein would be incapable of transferring a substrate from n+1 to n+2 without recalibration of the handler and/or gripping devices, which would consume a significant amount of time. The substrate handler of the present invention, however, can easily transfer a substrate from n+1 to n+2 without recalibration, because each gripping assembly is independently movable within a range of distance along its respective track. Therefore, each gripping assembly may be programmed, by software rather than by physical adjustment, to travel a different vertical distance to reach a given substrate support.

Furthermore, the independence of the substrate gripping assemblies also makes it possible to space cleaning modules more efficiently. For example, suppose the cleaning module n is thinner and smaller than the modules n+1 and n+2, which are roughly equal in size. Because previous substrate handler designs feature gripping assemblies that are controlled simultaneously and spaced equal distances apart, the cleaning modules used with these handlers need to be spaced so that the substrate reference points (i.e. R₁ or R₂) are separated by the same equal horizontal distance (i.e. D₁ or D₂). Thus the thinner cleaning module n would need to be spaced from the module n+1 by a distance x₁ that is greater than the distance x₂ separating modules n+1 and n+2 in order to compensate for the smaller size of module n. This increases the overall footprint of the cleaner. However, because the substrate handler of the present invention features independently controllable gripping assemblies, one gripping device at a time may be activated to enter a cleaning module and remove or replace a substrate, while the other gripping device remains inactive and other cleaning modules are unaffected. Thus, the substrate reference points do not necessarily need to be separated by equal distances, and the individual cleaning modules may be moved closer together, making the overall footprint of the cleaner smaller.

Thus the present invention represents a significant advancement in the field of semiconductor substrate cleaning and polishing. The substrate handler is adapted to support and transfer vertically oriented substrates, allowing it to be used in conjunction with cleaning systems that use minimal space. Furthermore, the handler is capable of multiple axes of vertical motion, making it more versatile and more easily adaptable to various substrate processing sequences.

While the foregoing is directed to embodiments of the invention, other and further embodiments of the invention may be devised without departing from the basic scope thereof, and the scope thereof is determined by the claims that follow.

What is claimed is:

1. A substrate handler for transporting a substrate comprising:
a carriage assembly positionable along a first axis of motion;
a first substrate gripper assembly coupled to the carriage assembly and positionable relative to the carriage assembly along a second axis of motion oriented substantially perpendicular to the first axis of motion; and
a second substrate gripper assembly coupled to the carriage assembly and positionable relative to the carriage assembly along a third axis of motion oriented substantially parallel to the second axis of motion, wherein the second gripper assembly is independently movable along the third axis relative to the first gripper assembly.

2. The substrate handler of claim 2, wherein the carriage assembly further comprises:
a horizontal track extending along the first axis;
a carriage coupled to the horizontal track; a motor; and
an actuator that cooperates with the motor to position the carriage along the horizontal track.

3. The substrate handler of claim 2, further comprising a mounting plate that extends perpendicular to the first axis of motion and couples the carriage assembly to the first and second substrate gripper assemblies, which are movably disposed on the mounting plate.

4. The substrate handler of claim 3, wherein each of the first and second substrate gripper assemblies comprises:
a vertical track coupled to the mounting plate;
a substrate gripper coupled to the vertical track; and
an actuator for positioning the substrate gripper along the vertical track.

5. The substrate handler of claim 4, wherein each of the substrate grippers has a substrate gripping motion in an axis that is substantially perpendicular to the first and second axes of motion.

6. The substrate handler of claim 5, wherein the first substrate gripper further comprises:
a first end effector;
a second opposing end effector; and
an actuator adapted to move at least one of the first and second end effectors toward the other end effector.

7. The substrate handler of claim 1, wherein the first substrate gripper assembly further comprises:
a substantially U-shaped blade having a first end and an opposing second end;
a first end effector coupled to the first end of the blade; and
a second end effector coupled to the second end of the blade.

8. The substrate handler of claim 7, wherein the first and second end effector each comprises:
a body having an inner surface;
a first flange extending inwardly from the inner surface; a second flange extending inwardly from the inner surface in a spaced apart relation to the first flange; and
a substrate support extending from the inner surface between the first and second flanges and defining a substrate receiving pocket with the first and second flanges.

9. The substrate handler of claim 8, wherein the second flange extends a greater distance from the substrate support than the first flange.

10. The substrate support of claim 8, wherein the second flange extends inward a greater distance from the inner surface than the first flange.

11. The substrate handler of claim 8, wherein a least one of the first and second end effectors further comprises a substrate sensor.

12. The substrate handler of claim 11, wherein the substrate sensor further comprises a fiber optic sensor coupled to the end effector.

13. A semiconductor substrate cleaning system comprising:
a substrate cleaner having a plurality of cleaning modules;
a first substrate gripper assembly selectively positionable over each of the plurality of cleaning modules; and
a second substrate gripper assembly selectively positionable over each of the plurality of cleaning modules, wherein the first gripper moves vertically to interface with the cleaning modules independent of the second gripper assembly.

14. The semiconductor substrate cleaning system of claim 13, further comprising a carriage assembly positionable along a first axis of motion and having the first and second substrate gripper assemblies coupled thereto, wherein the first axis of motion is substantially perpendicular to the motion of the first and second substrate gripper assemblies.

15. The semiconductor substrate cleaning system of claim 14, wherein the carriage assembly further comprises:
a horizontal track;
a carriage mounted to the horizontal track and having the first and second substrate gripper assemblies coupled thereto; and
an actuator adapted to position the carriage along the horizontal track.

16. The semiconductor substrate cleaning system of claim 15, wherein each of the first and second substrate gripper assemblies comprises:
a vertical track coupled to the carriage;
a substrate gripper mounted on the vertical track; and
an actuator for positioning the substrate gripper along the vertical track.

17. The semiconductor substrate cleaning system of claim 16, wherein the substrate gripper has a substrate gripping motion in an axis that is substantially perpendicular to the first and second axes of motion.

18. The substrate handler of claim 17, wherein the first substrate gripper further comprises:
a first end effector;
a second opposing end effector; and
an actuator adapted to move at least one of the first and second end effectors toward the other end effector.

19. The semiconductor substrate cleaning system of claim 16, wherein the substrate gripper further comprises:
a substantially U-shaped blade having a first end and an opposing second end;
a first end effector coupled to the first end of the blade; and
a second end effector coupled to the second end of the blade.

20. The semiconductor substrate cleaning system of claim 19, wherein the first and second end effector each comprises:
a body having an inner surface;
a first flange extending inwardly from the inner surface;
a second flange extending inwardly from the inner surface in a spaced apart relation to the first flange; and
a substrate support extending from the inner surface between the first and second flanges and defining a substrate receiving pocket with the first and second flanges.

21. The semiconductor substrate cleaning system of claim 20, wherein the second flange extends a greater distance from the substrate support than the first flange.

22. The semiconductor substrate cleaning system of claim 21, wherein second flange extends inward a greater distance from the inner surface than the first flange.

23. The semiconductor substrate cleaning system of claim 20, wherein at least one of the first and second end effectors further comprises a fiber optic sensor coupled to the end effector and adapted to sense a substrate disposed in the substrate receiving pockets.

24. A cleaning system comprising:
a plurality of cleaning modules;
a carriage assembly movable along a first axis of motion;
a first substrate gripper assembly coupled to the carriage and movable along a second axis of motion substantially perpendicular to the first axis; and
a second substrate gripper assembly coupled to the carriage and independently movable relative to the first substrate gripper along a third axis of motion substantially parallel to the second axis,
wherein the first and second gripper assemblies may be positioned along the first axis so that the second and third axes are selectively aligned with a predetermined one of the plurality of cleaning modules.

25. The cleaning system of claim 24, wherein the carriage assembly further comprises:
a horizontal track;
a carriage mounted to the horizontal track and having the first and second substrate gripper assemblies coupled thereto; and
an actuator adapted to position the carriage along the horizontal track.

26. The cleaning system of claim 25, wherein each of the first and second substrate gripper assemblies comprises:
a vertical track coupled to the carriage;
a substrate gripper mounted on the vertical track and having a substrate gripping motion in an axis that is substantially perpendicular to the first and second axes of motion; and
an actuator for positioning the substrate gripper along the vertical track.

27. The cleaning system of claim 26, wherein first substrate gripper further comprises:
a first end effector;
a second opposing end effector; and
an actuator adapted to move at least one of the first and second end effectors towards the other end effector.

28. The cleaning system of claim 27, wherein the substrate gripper further comprises:
a substantially U-shaped blade having a first end and an opposing second end;
a first end effector coupled to the first end of the blade; and a second end effector coupled to the second end of the blade.

29. The cleaning system of claim 28, wherein the first and second end effector each comprises:
a body having an inner surface;
a first flange extending inwardly from the inner surface;
a second flange extending inwardly from the inner surface in a spaced relation to the first flange; and
a substrate support extending from the inner surface between the first and second flanges and defining substrate receiving pocket with the first and second flanges.

30. The cleaning system of claim 29, wherein the second flange extends a greater distance from the substrate support than the first flange.

31. The cleaning system of claim 30, wherein the second flange extends inward a greater distance from the inner surface than the first flange.

32. The cleaning system of claim 28, wherein at least one of the first and second end effectors further comprises a fiber optic sensor coupled to the end effector and adapted to sense a substrate disposed in the receiving pockets.

33. A substrate handler comprising:
means for positioning a first and second gripping means along a first axis of motion;
first gripping means coupled to the positioning means and positionable along a second axis of motion oriented substantially perpendicular to the first axis of motion; and
second gripping means coupled to the positioning means and positionable along a third axis of motion oriented substantially parallel to the second axis of motion, wherein the second gripping means is independently movable relative to the first gripping means, wherein the first and second gripping means have a substrate gripping motion in a direction that is substantially perpendicular to the first and second axes of motion.

34. The substrate handler of claim 33, wherein the first and second gripping means have fixed spacing along the first axis.

35. The substrate handler of claim 34, wherein first gripping means further comprises:
a first end effector;
a second opposing end effector; and
an actuator adapted to move at least one of the first and second end effectors towards the other end effector.

36. The substrate handler of claim 33, wherein each of the first and second gripping means further comprises:
a substantially U-shaped blade having a first end and an opposing second end;
a first end effector coupled to the first end of the blade; and
a second end effector coupled to the second end of the blade.

37. The substrate handler of claim 36, wherein the first and second end effector each comprises:
a body having an inner surface;
a first flange extending inwardly from the inner surface;
a second flange extending inwardly from the inner surface in a spaced apart relation to the first flange; and
a substrate support extending from the inner surface between the first and second flanges and defining a substrate receiving pocket with the first and second flanges.

38. The substrate handler of claim 37, wherein the second flange extends a greater distance from the substrate support than the first flange.

39. The substrate handler of claim 37, wherein the second flange extends inward a greater distance from the inner surface than the first flange.

40. The substrate handler of claim 37, wherein at least one of the first and second end effectors further comprises a fiber optic sensor coupled to the end effector and adapted to sense a substrate.

41. A method for transferring vertically oriented substrates in a substrate cleaning device, comprising:
retrieving a first substrate with a first gripper from a first cleaning module; aligning a second gripper over the first cleaning module;
transferring a second substrate from the second gripper to the first cleaning module;
moving the first and second grippers laterally;
aligning the second gripper over a second cleaning module;
retrieving a third substrate from the second cleaning module;
aligning the first gripper over the second cleaning module; and
transferring the first substrate to the second cleaning module.

42. The method of claim 41, wherein the first and second cleaning modules are adjacent.

43. The method of claim 41, wherein at least one additional cleaning module is positioned between the first and second cleaning modules.

44. An apparatus for picking up a vertically oriented substrate, comprising:
a connecting member;
a first arm coupled at a first end to the connecting member;
a second arm coupled at a first end to the connecting member;
a first end effector disposed at a second end of the first arm and having a first substrate receiving pocket facing the second arm; and
a second end effector disposed at a second end of the second arm and having a second substrate receiving pocket facing the first arm,
wherein the first and second substrate receiving pockets are adapted to support a substrate therebetween.

45. The apparatus of claim 44, wherein the first end effector further comprises:
a first flange extending towards the second arm; and
a second flange extending towards the second arm in a spaced-apart relation relative to the first flange and defining the substrate receiving pocket of the first end effector.

46. The apparatus of claim 45, wherein the first flange extends closer to the second arm than the second flange.

47. The apparatus of claim 45, wherein the first end effector further comprises:
a support surface disposed between the first flange and the second flange, the support surface oriented at an acute angle relative to a centerline passing through the connecting member and defined between the first and second arms.

48. The apparatus of claim 45, first end effector further comprises:
a support surface disposed between the first flange and the second flange and extending towards the second arm from the first end effector.

49. The apparatus of claim 44 further comprising:
an optical sensor adapted to detect a substrate disposed in at least one of the substrate receiving pockets of the first or the second arms.
